(19) United States
(12) Patent Application Publication
(10) Pub. No.: US 2023/0047463 A1
(43) Pub. Date: Feb. 16, 2023

(54) SECURITY ECOSYSTEM

(71) Applicant: MOTOROLA SOLUTIONS, INC., Chicago, IL (US)

(72) Inventors: BING QIN LIM, BAYAN LEPAS (MY); CHUN MENG TAN, BAYAN LEPAS (MY); WOEI CHUN TAN, BAYAN LEPAS (MY); JIN HOE PHUA, CHENDERIANG (MY)

(21) Appl. No.: 17/445,095

(22) Filed: Aug. 16, 2021

(51) Int. Cl. G06Q 10/06; G06K 9/00

(52) U.S. Cl. CPC G06Q 10/063116; G06Q 10/0633; G06K 9/00711; G06K 2009/00738

(57) ABSTRACT

A system, method, and apparatus for implementing workflows across multiple differing systems and devices is provided herein. During operation, a workflow is automatically generated based upon a high probability of overloading resources with a current workflow. In particular, a workstation (or server) detects a high probability that a resource will be overloaded if a particular trigger is implemented. The workstation (or server) then determines an alternate trigger to reduce the chances that a resource will be overloaded. The alternate trigger and action can then be implemented or suggested as a newly-created workflow.

### BACKGROUND OF THE INVENTION

Managing multiple devices within a security ecosystem can be a time-consuming and challenging task. This task typically requires an in-depth knowledge of each type of device within the security ecosystem in order to produce a desired workflow when a security event is detected. For example, consider a school system that employs a security ecosystem comprising a radio communication system, a video security system, and a door access control system. Assume that an administrator wishes to implement a first workflow that notifies particular radios if a door breach is detected. Assume that the administrator also wishes to implement a second workflow that also notifies the particular radios when a security camera detects loitering. In order to implement these two workflows, the access control system will have to be configured to provide the notifications to the radios and the video security system will have to be configured to provide the notifications to the radios. Thus, both the access control system and the video security system will need to be configured separately in order to implement the two workflows. As is evident, this requires the administrator to have an in-depth knowledge of both the video security system and the access control system. Thus, the lack of continuity across systems is a burden to administrators since an in-depth knowledge of all systems within the ecosystem will be needed in order to properly configure workflows within the ecosystem.

In order to reduce the burden on administrators and enhance their efficiency, a need exists for a user-friendly interface tool that gives administrators the ability to configure and automate workflows that control their integrated security ecosystem. It would also be beneficial if such a tool equips administrators with the capabilities they need to detect triggers across a number of installed devices/systems and quickly take actions (execute workflows) to reduce the risk of breaches and downtime by automatically alerting the appropriate teams and executing the proper procedures.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1a illustrates a security ecosystem capable of configuring and automating workflows.

FIG. 1b illustrates a security ecosystem capable of configuring and automating workflows.

FIG. 1c illustrates a security ecosystem capable of configuring and automating workflows.

FIG. 1d illustrates a security ecosystem capable of configuring and automating workflows.

FIG. 1e illustrates a security ecosystem capable of configuring and automating workflows.

FIG. 2 is a block diagram of a workflow server of FIG. 1.

FIG. 3 is a block diagram of a workstation of FIG. 1 utilized to create a workflow.

FIG. 4 illustrates the creation of a workflow.

FIG. 5 illustrates the creation of a workflow.

FIG. 6 illustrates the creation of a workflow.

FIG. 7 illustrates resource loading for various time periods.

FIG. 8 illustrates a new workflow presented to a user.

FIG. 9 illustrates a new workflow presented to a user.

FIG. 10 illustrates a new workflow presented to a user.

FIG. 11 illustrates a new workflow presented to a user.

FIG. 12 is a flow chart showing operation of the workstation of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a system, method, and apparatus for implementing workflows across multiple differing systems and devices is provided herein. During operation a workflow is automatically modified or generated based upon a high probability of overloading resources with a current workflow. In particular, a workstation (or server) detects a high probability that a resource will be overloaded if a particular trigger is implemented. The workstation (or server) then determines an alternate trigger to reduce the chances that a resource will be overloaded. The alternate trigger and action can then be implemented or suggested as a newly-created workflow.

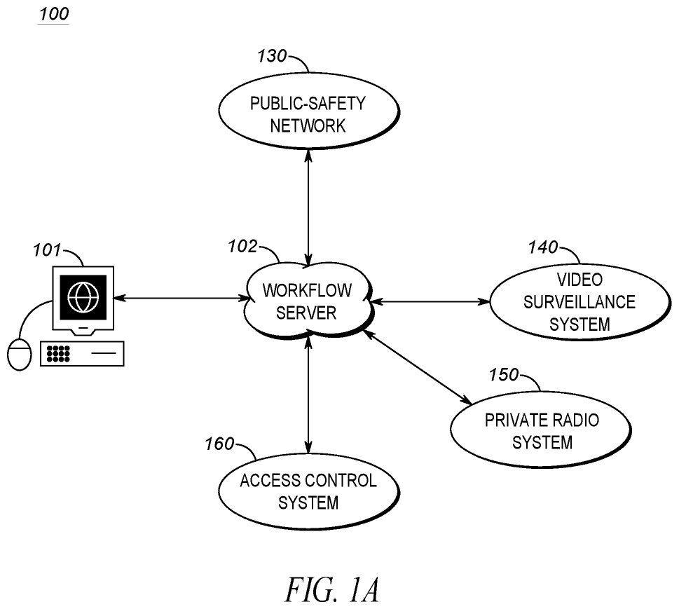

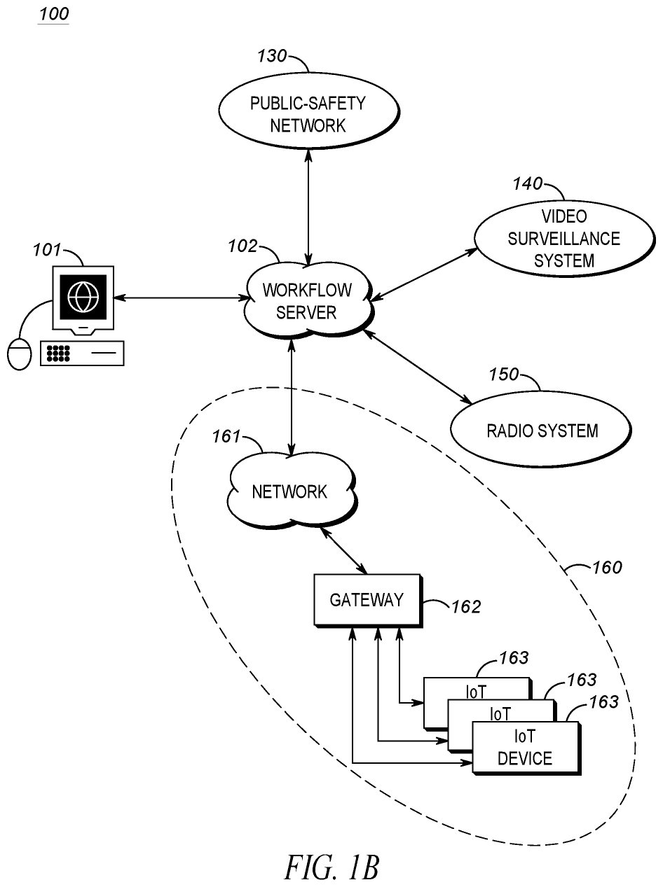

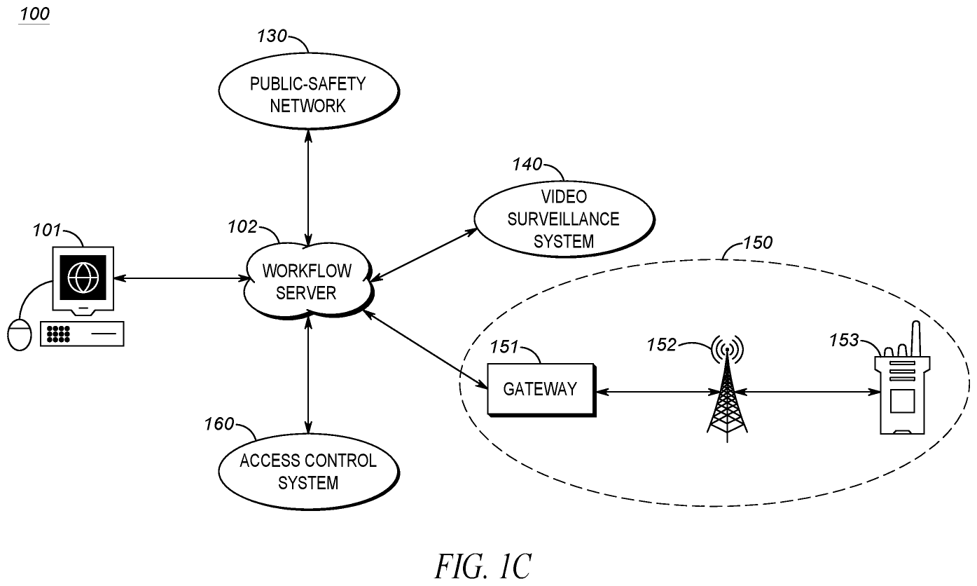

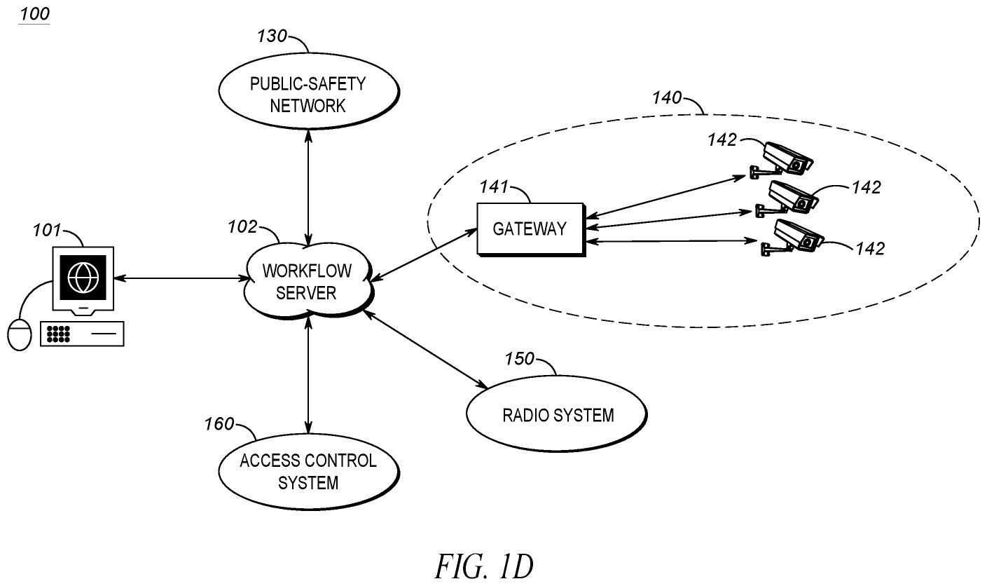

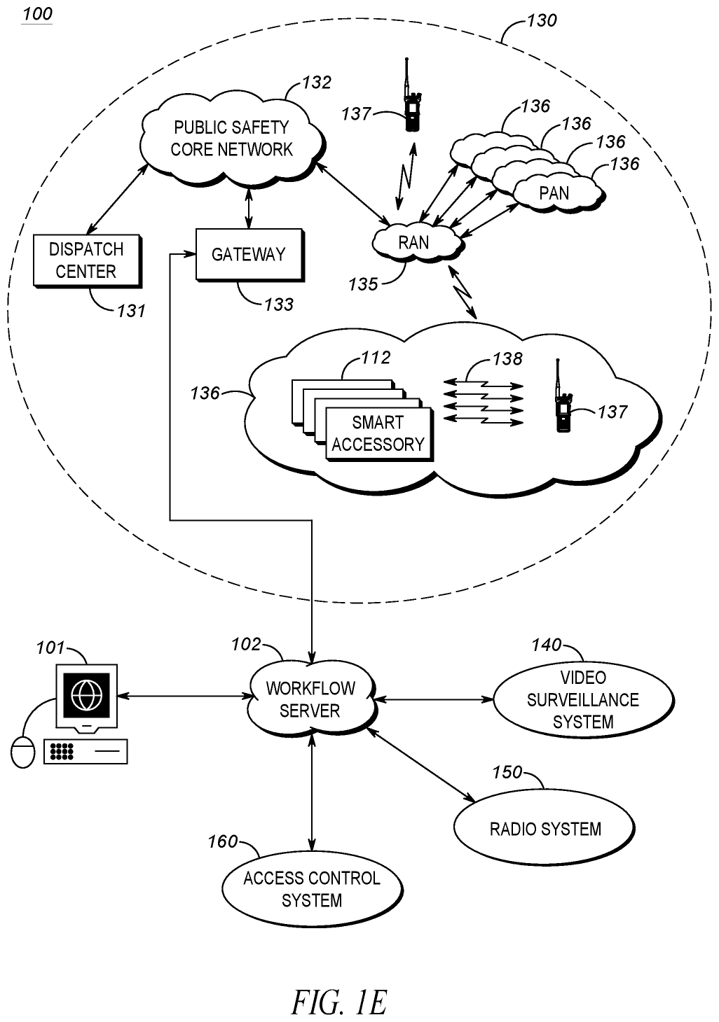

Turning now to the drawings, wherein like numerals designate like components, FIG. 1a illustrates security ecosystem 100 capable of configuring and automating workflows across multiple systems. As shown, security ecosystem 100 comprises public-safety network 130, video surveillance system 140, private radio system 150, and access control system 160. Workflow server 102 is coupled to each system 130, 140, 150, and 160. Workstation 101 is shown coupled to workflow server 102, and is utilized to configure server 102 with workflows created by a user. It should be noted that although the components in FIG. 1 are shown geographically separated, these components can exist within a same geographic area, such as, but not limited to a school, a hospital, an airport, a sporting event, a stadium, . . . , etc. It should also be noted that although only networks and systems 130-160 are shown in FIG. 1a, one of ordinary skill in the art will recognize that many more networks and systems may be included in ecosystem 100.

Workstation 101 is preferably a computer configured to execute Motorola Solution's Orchestrate™ and Ally™ dispatch and incident management software. As will be discussed in more detail below, workstation 101 is configured to present a user with a plurality of triggers capable of being detected by network and systems 130-160 as well as present the user with a plurality of actions capable of being executed by network and systems 130-160. The user will be able to create workflows and upload these workflows to workflow server 102 based on the presented triggers and actions.

Workflow server 102 is preferably a server running Motorola Solution's Command Central™ software suite comprising the Orchestrate™ platform. Workflow server 102 is configured to receive workflows created by workstation 101 and implement the workflows. Particularly, the workflows are implemented by analyzing events detected by network and systems 130-160 and executing appropriate triggers. For example, assume a user creates a workflow on workstation 101 that has a trigger comprising surveillance system 140 detecting a loitering event, and has an action comprising notifying radios within public-safety network 130. When this workflow is uploaded to workflow server 102, workflow server 102 will notify the radios of any loitering event detected by surveillance system 140.

Public-safety network 130 is configured to detect various triggers and report the detected triggers to workflow server 102. Public-safety network 130 is also configured to receive action commands from workflow server 102 and execute the actions. In one embodiment of the present invention, public-safety network 130 comprises includes typical radio-access network (RAN) elements such as base stations, base station controllers (BSCs), routers, switches, and the like, arranged, connected, and programmed to provide wireless service to user equipment, report detected events, and execute actions received from workflow server 102.

Video surveillance system 140 is configured to detect various triggers and report the detected triggers to workflow server 102. Public-safety network 130 is also configured to receive action commands from workflow server 102 and execute the actions. In one embodiment of the present invention, video surveillance system 140 comprises a plurality of video cameras that may be configured to automatically change their field of views over time. Video surveillance system 140 is configured with a recognition engine/video analysis engine (VAE) that comprises a software engine that analyzes any video captured by the cameras. Use the VAE, the video surveillance system 140 is capable of “watching” video to detect any triggers and report the detected triggers to workflow server 102. In a similar manner, video surveillance system 140 is configured to execute action commands received from workflow server 102. In one embodiment of the present invention, video surveillance system 140 comprises an Avigilon™ Control Center (ACC) server having Motorola Solution's Access Control Management (ACM)™ software suite.

Radio system 150 preferably comprises a private enterprise radio system that is configured to detect various triggers and report the detected triggers to workflow server 102. Radio system 150 is also configured to receive action commands from workflow server 102 and execute the actions. In one embodiment of the present invention, radio system 150 comprises a MOTOBRO™ communication system having radio devices that operate in the CBRS spectrum and combines broadband data with voice communications.

Finally, access control system 160 comprises an IoT network. IoT system 160 serves to connect every-day devices to the Internet. Devices such as cars, kitchen appliances, medical devices, sensors, doors, windows, HVAC systems, drones, . . . , etc. can all be connected through the IoT. Basically, anything that can be powered can be connected to the internet to control its functionality. System 160 allows objects to be sensed or controlled remotely across existing network infrastructure. For example, access control system 160 may be configured to provide access control to various doors and windows. With this in mind, access control system 160 is configured to detect various triggers (e.g., door opened/closed) and report the detected triggers to workflow server 102. Access control system 160 is also configured to receive action commands from workflow server 102 and execute the action received from workflow server 102. The action commands may take the form of instructions to lock, open, and/or close a door or window.

As is evident, the above security ecosystem 100 allows an administrator using workstation 101 to create rule-based, automated workflows between technologies to enhance efficiency, and improve response times, effectiveness, and overall safety. The above ecosystem 100 has the capabilities to detect triggers across a number of devices within network and systems 130-160 quickly take actions by automatically executing the proper procedure (i.e., executing the appropriate action once a trigger is detected).

FIG. 1B illustrates a security ecosystem capable of configuring and automating workflows. In particular, FIG. 1B shows security ecosystem 100 with an expanded view of access control system 160. As shown, access control system 160 comprises a plurality of IoT devices 163 coupled to gateway 162. Data passed from workflow server 102 to IoT devices 163 passes through network 161, gateway 162 and ultimately to IoT device 163. Conversely, data passed from IoT devices 163 to workflow server 102 passes through gateway 162, network 161, and ultimately to workflow server 102.

IoT devices 163 preferably comprise devices that control objects, doors, windows, sensors, . . . , etc. As is known in the art, a particular communication protocol (IoT protocol) may be used for each IoT device. For example, various proprietary protocols such as DNP, Various IEC**** protocols (IEC 61850 etc. . . . ), bacnet, EtherCat, CANOpen, Modbus/Modbus TCP, EtherNet/IP, PROFIBUS, PROFINET, DeviceNet, . . . , etc. can be used. Also a more generic protocol such as Coap, Mqtt, and RESTfull may also be used.

Gateway 162 preferably comprises an Avigilon™ Control Center running Avigilon's Access Control Management software. Gateway 162 is configured to run the necessary Application Program Interface (API) to provide communications between any IoT device 163 and workflow server 102.

Network 161 preferably comprises one of many networks used to transmit data, such as but not limited to a network employing one of the following protocols: a Long Term Evolution (LTE) protocol, LTE-Advance protocol, or 5G protocol including multimedia broadcast multicast services (MBMS) or single site point-to-multipoint (SC-PTM) protocol over which an open mobile alliance (OMA) push to talk (PTT) over cellular protocol (OMA-PoC), a voice over IP (VoIP) protocol, an LTE Direct or LTE Device to Device protocol, or a PTT over IP (PoIP) protocol, a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

FIG. 1c illustrates a security ecosystem capable of configuring and automating workflows. In particular, FIG. 1c shows security ecosystem 100 with an expanded view of radio system 150. As shown, radio system 150 comprises gateway 151, system infrastructure 152, and at least one radio 153. Communications from radio 153 to workflow server 102 passes through infrastructure 152, gateway 151, and ultimately to workflow server 102.

Gateway 151 preferably comprises an Avigilon™ Control Center running Avigilon's Access Control Management software. Gateway 151 is configured to run the necessary Application Program Interface (API) to provide communications between any infrastructure 152 and workflow server 102.

Infrastructure 152 comprises the necessary equipment to provide wireless communications to and from radio 153. Preferably, infrastructure 152 comprises Motorola Solutions MOTOBRO™ equipment, such as an SLR Series Repeater (e.g., SLR 1000, SLR 5000, or SLR8000 repeater) configured to provide two-way radio service to radio 153.

Although only a single radio 153 is shown in FIG. 1c, one of ordinary skill in the art will recognize that many radios 153 may be present within radio system 150. Each radio 153 preferably comprises a MOTOBRO™ two-way radio (such as a Motorola Solution XPR 5000 Series radio) with digital technology providing integrated voice and data communication.

FIG. 1d illustrates a security ecosystem capable of configuring and automating workflows. In particular, FIG. 1d shows security ecosystem 100 with an expanded view of video surveillance system 140. As shown, video surveillance system 140 comprises a plurality of cameras 142 and gateway 141.

Cameras 142 may be fixed or mobile, and may have pan/tilt/zoom (PTZ) capabilities to change their field of view. Cameras 142 may also comprise circuitry configured to serve as a video analysis engine (VAE) which comprises a software engine that analyzes analog and/or digital video. The engine is configured to “watch” video and detect pre-selected objects such as license plates, people, faces, automobiles. The software engine may also be configured to detect certain actions of individuals, such as fighting, loitering, crimes being committed, . . . , etc. The VAE may contain any of several object/action detectors. Each object/action detector “watches” the video for a particular type of object or action. Object and action detectors can be mixed and matched depending upon what is trying to be detected. For example, an automobile object detector may be utilized to detect automobiles, while a fire detector may be utilized to detect fires.

Gateway 141 preferably comprises an Avigilon™ Control Center running Avigilon's Access Control Management software. Gateway 141 is configured to run the necessary Application Program Interface (API) to provide communications between any cameras 142 and workflow server 102.

FIG. 1e illustrates a security ecosystem capable of configuring and automating workflows. In particular, FIG. 1e shows security ecosystem 100 with an expanded view of public safety network 130. As shown, public-safety network 130 comprises gateway 133, public-safety core network 132, dispatch center 131, radio access network (RAN) 135, at least one public-safety radio 137, and a plurality of personal-area networks (PANs) 136. As shown, each PAN 136 comprises radio 137 acting as a hub to smart devices/accessories 112.

Gateway 133 preferably comprises an Avigilon™ Control Center running Avigilon's Access Control Management software. Gateway 133 is configured to run the necessary Application Program Interface (API) to provide communications between public-safety core network 132 and workflow server 102.

A public safety officer (not shown in FIG. 1e) will be equipped with devices 112 that determine various physical and environmental conditions surrounding the public-safety officer. These conditions may be reported back to, for example, dispatch center 131 or workflow server 102 so an appropriate action may be taken. For example, future police officers may have a sensor 112 that determines when a gun is drawn. Upon detecting that an officer has drawn their gun, a notification may be sent back to the dispatch operator and/or workflow server 102 so that, for example, other officers in the area may be notified of the situation.

It is envisioned that the public-safety officer will have an array of these shelved devices 112 available to the officer at the beginning of a shift. The officer will select devices 112 off the shelf, and form a personal area network (PAN) with the devices that will accompany the officer on their shift. For example, the officer may pull a gun-draw sensor, a body-worn camera, a wireless microphone, a smart watch, a police radio, smart handcuffs, a man-down sensor, a bio-sensor, . . . , etc. All devices 112 pulled by the officer will be configured to form a PAN by associating (pairing) with each other and communicating wirelessly among the devices. At least one device may be configured with a digital assistant. In a preferred embodiment, the PAN comprises more than two devices, so that many devices may be connected via the PAN simultaneously.

A method called bonding is typically used for recognizing specific devices 112 and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device. Thus, as shown, public-safety communication system 130 incorporates PANs 136 created as described above. In a preferred embodiment of the present invention, radios 137 and devices 112 form PAN 136, with communication links 138 between devices 112 and radios 137 taking place utilizing a short-range communication system protocol such as a Bluetooth communication system protocol. In this particular embodiment, a pan will be associated with a single officer. Thus, FIG. 1e illustrates multiple PANs 136 associated with multiple officers (not shown).

RAN 135 includes typical RAN elements such as base stations, base station controllers (BSCs), routers, switches, and the like, arranged, connected, and programmed to provide wireless service to user equipment (e.g., radios 137, and the like) in a manner known to those of skill in the relevant art. RAN 135 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 135 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 135 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 132 may include one or more packet-switched networks and/or one or more circuit-switched networks, and in general provides one or more public-safety agencies with any necessary computing and communication needs, transmitting any necessary public-safety-related data and communications.

For narrowband LMR wireless systems, core network 132 operates in either a conventional or trunked configuration. In either configuration, a plurality of communication devices is partitioned into separate groups (talkgroups) of communication devices. In a conventional narrowband system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time.

Group calls may be made between radios 137 and other devices via wireless transmissions in accordance with either a narrowband or a broadband protocol or standard. Group members for group calls may be statically or dynamically defined. That is, in a first example, a user or administrator may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., join a group call having a particular talkgroup ID) with each of the pre-designated participants in the defined group. In another example, communication devices may dynamically affiliate with a group (and also disassociate with the group) perhaps based on user input, and the switching and/or radio network may track group membership and route new group calls according to the current group membership.

Radios 137 serves as a PAN main device, and may be any suitable computing and communication device configured to engage in wireless communication with the RAN 135 over the air interface as is known to those in the relevant art. Moreover, one or more radios 137 are further configured to engage in wired and/or wireless communication with one or more local device 112 via the communication link 138. Radios 137 will be configured to determine when to forward information received from PAN devices to, for example, a dispatch center or workflow server 102.

Some examples follow of devices 112 follow:

A sensor-enabled holster 112 may be provided that maintains and/or provides state information regarding a weapon or other item normally disposed within the user's sensor-enabled holster 112. The sensor-enabled holster 112 may detect a change in state (presence to absence) and/or an action (removal) relative to the weapon normally disposed within the sensor-enabled holster 112. The detected change in state and/or action may be reported to portable radio 137 via its short-range transceiver, which may forward the state change to dispatch center 131 or workflow server 102. In some embodiments, the sensor-enabled holster may also detect whether the first responder's hand is resting on the weapon even if it has not yet been removed from the holster and provide such information to portable radio 137.

A biometric sensor 112 (e.g., a biometric wristband) may be provided for tracking an activity of the user or a health status of a user, and may include one or more movement sensors (such as an accelerometer, magnetometer, and/or gyroscope) that may periodically or intermittently provide to the portable radio 137 indications of orientation, direction, steps, acceleration, and/or speed, and indications of health such as one or more of a captured heart rate, a captured breathing rate, and a captured body temperature of the user, perhaps accompanying other information. This information may be reported to radio 137 which may forward the information to dispatch center 131 and/or workflow server 102.

An accelerometer 112 may be provided to measures acceleration. Single and multi-axis models are available to detect magnitude and direction of the acceleration as a vector quantity, and may be used to sense orientation, acceleration, vibration shock, and falling. The accelerometer 112 may determine if an officer is running. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing. This information may be reported to radio 137 which may forward the information to dispatch center 131 and/or workflow server 102.

A heart rate sensor 112 may be provided and use electrical contacts with the skin to monitor an electrocardiography (EKG) signal of its wearer, or may use infrared light and imaging device to optically detect a pulse rate of its wearer, among other possibilities. This information may be reported to radio 137 which may forward the information to dispatch center 131 and/or workflow server 102.

A breathing rate sensor 112 may be provided to monitor breathing rate. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well. This information may be reported to radio 137 which may forward the information to dispatch center 131 and/or workflow server 102.

Dispatch center 131 comprises, or is part of, a computer-aided-dispatch center (sometimes referred to as an emergency-call center or public-safety answering point), that may be manned by an operator providing necessary dispatch operations. For example, dispatch center 131 typically comprises a graphical-user interface that provides the dispatch operator necessary information about public-safety officers. As discussed above, some of this information originates from devices 112 providing information to radios 137, which forwards the information to RAN 135 and ultimately to dispatch center 131.

In a similar manner information about public-safety officers may be provided to workflow server 102. This information originates from devices 112 providing information to radios 137, which forwards the information to RAN 135 and ultimately to workflow server 102 via core network 132 and gateway 133. For example, a gun-draw sensor 112 may send an indication to workflow server 102 that a gun has been drawn. This may serve as a “trigger” for workflow server 102 to initiate a particular “action”, for example, notifying surrounding officers (for example on a particular talkgroup) by having their radios 137 provide an alarm indicating the triggering event. Thus, workflow server 102 may provide instructions to any device 112 or radio 137 by sending an “action” to devices 112 in response to a trigger being received.

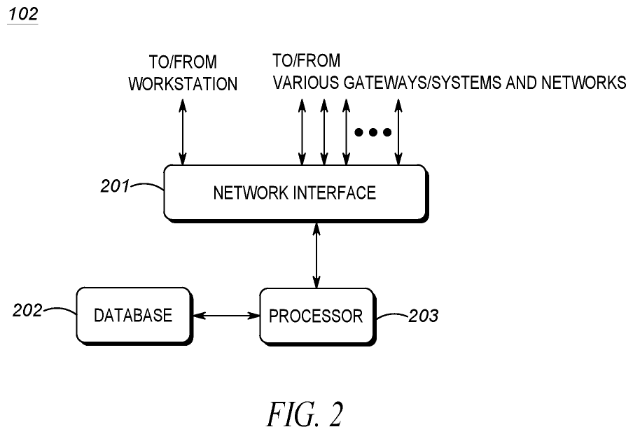

FIG. 2 is a block diagram of a workflow server of FIG. 1. As shown, workflow server 102 comprises network interface 201, database 202, and processor (serving as logic circuitry) 203.

Network interface 201 includes elements including processing, modulating, and transceiver elements that are operable in accordance with any one or more standard or proprietary wireless interfaces, wherein some of the functionality of the processing, modulating, and transceiver elements may be performed by means of processor 203 through programmed logic such as software applications or firmware stored on the storage component 202 (e.g., standard random access memory) or through hardware. Examples of network interfaces (wired or wireless) include Ethernet, T1, USB interfaces, IEEE 802.11b, IEEE 802.11g, etc.

Logic circuitry 203 comprises a digital signal processor (DSP), general purpose microprocessor, a programmable logic device, or application specific integrated circuit (ASIC) and is configured to receive triggers from various gateways, systems, and networks. Once a trigger is received, logic circuitry 203 is configured to execute (or cause to be executed) a particular action for the trigger. More particularly, when logic circuitry 203 receives a trigger from any attached network or system, logic circuitry will access database 202 to determine an action for the particular trigger. Once an action has been determined, logic circuitry will execute the action, or cause the action to be executed. In order to perform the above, logic circuitry executes an instruction set/software (e.g., Motorola Solution's Command Central™ software suite comprising the Orchestrate™ platform) stored in database 202.

Database 202 comprises standard memory (such as RAM, ROM, . . . , etc) and serves to store associations between triggers and actions. This is illustrated in Table 1, below.

TABLE 1
Associations Between Triggers and Actions.

| Trigger | Action |
|---|---|
| Warehouse back door opened | Pan camera 342 to point at door |
| Man-Down sensor activated for | Notify dispatch center via |
| Officer Smith | emergency text message |
| ALPR for delivery truck | Open back gate |
| . . . etc. | . . . etc. |

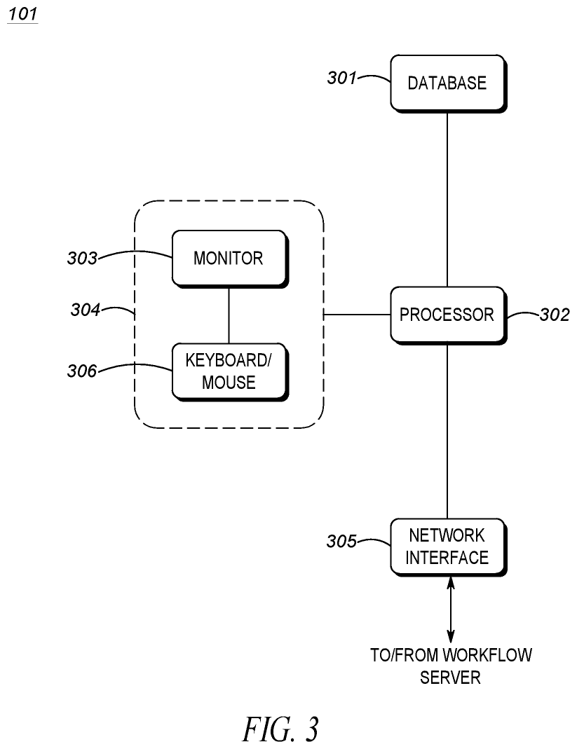

FIG. 3 is a block diagram of a workstation of FIG. 1 utilized to create a workflow. As shown, workstation 101 comprises database 301, processor 302, graphical-user interface 304, and network interface 305.

Network interface 305 includes elements including processing, modulating, and transceiver elements that are operable in accordance with any one or more standard or proprietary wireless interfaces, wherein some of the functionality of the processing, modulating, and transceiver elements may be performed by means of processor 302 through programmed logic such as software applications or firmware stored on the storage component 301 (e.g., standard random access memory) or through hardware. Examples of network interfaces (wired or wireless) include Ethernet, T1, USB interfaces, IEEE 802.11b, IEEE 802.11g, etc.

Logic circuitry 302 comprises a digital signal processor (DSP), general purpose microprocessor, a programmable logic device, or application specific integrated circuit (ASIC) and is configured to execute Motorola Solution's Orchestrate™ and Ally™ dispatch and incident management software from storage 301. The execution of such software will allow users of GUI 304 to create workflows (i.e., actions and their associated responses) by receiving user inputs from GUI 304 that define various triggers and their associated actions, which will ultimately be uploaded to workflow server 102 and stored in database 202.

Database 301 comprises standard memory (such as RAM, ROM, . . . , etc) and serves to store instructions as software. Particularly, Motorola Solution's Orchestrate™ and Ally™ dispatch and incident management software is stored in database 301.

GUI 304 provides a man/machine interface for receiving an input from a user and displaying information. For example, GUI 304 provides a way of conveying (e.g., displaying) user-created workflows. Thus, GUI 304 also provides means for a user to input workflows into a displayed form. In order to provide the above features (and additional features), GUI 304 may comprises any combination of monitor 303 (e.g., touch screen, a computer screen, . . . , etc.) and keyboard/mouse combination 306.

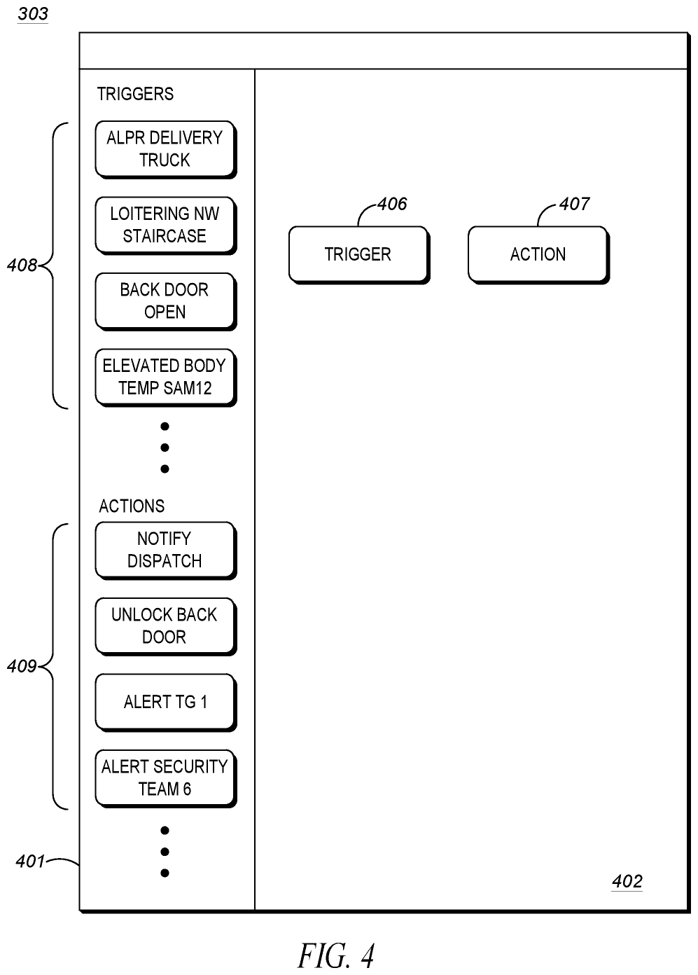

FIG. 4 illustrates the creation of a workflow. More particularly, FIG. 4 illustrates a dashboard displayed on monitor 303 utilized for the creation of workflows. The dashboard consists of the following main elements:
selection pane 401 on the left-hand side, which comprises the available triggers 408 and actions 409;
workspace 402, which comprises the large area in the middle of the dashboard used to create workflows that define the connections between products. Each workflow in the workspace is displayed as a separate field 406 and 407 with an outline and a title. As shown in FIG. 4, two fields 406 and 407 are shown, one labeled “trigger” and another labeled “action”.

Triggers 408 represent the events originating from various sensors, software, and devices within security ecosystem 100. Actions 409 represent the possible responses to the triggers.

After a workflow is deployed (i.e., uploaded to workflow server 102), its actions activate when the triggers occur. Triggers and actions appear on the workspace after they are dragged and dropped from the triggers 408 and actions 409 tabs respectively. Connecting the triggers and actions on the workspace (as described below) will create a workflow.

All triggers 408 and actions 409 are stored in database 301 and represent integrations across multiple products. In other words, triggers and actions comprise triggers and actions for all of the components available in security ecosystem 100. This includes cameras, sensors, IoT devices, radios, . . . , etc. As administrators add additional technology pieces to security ecosystem 100, those pieces are automatically made available for workflow creation as discussed herein.

In order to associate a trigger with an action, a user selects a trigger from all possible triggers 406, and drags and drops it onto workspace area 402. The user then selects an action for the trigger, and drags and drops it onto workspace area 402. In order to associate the trigger with the action, they must be connected. To connect the trigger and actions, a user will click the end of one of the node, and drag a line to the other node.

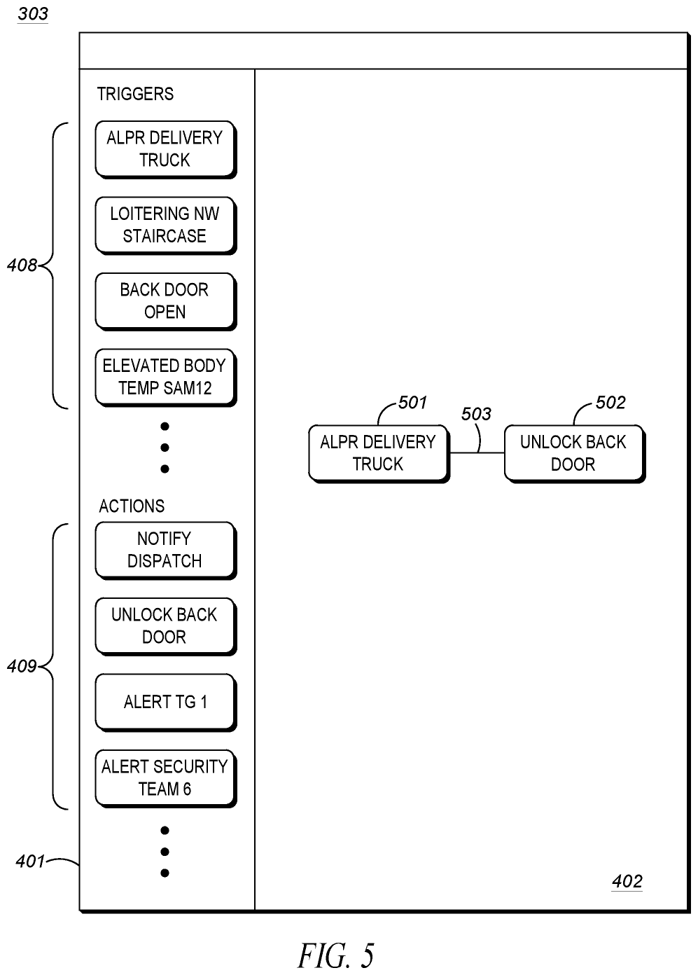

As shown in FIG. 5, a trigger “ALPR delivery truck” 501 has been associated with an action “unlock back door” 502 by dragging line 503 between the two. If any of the triggers within a trigger group occurs, the workflow is initiated causing the action to be executed.

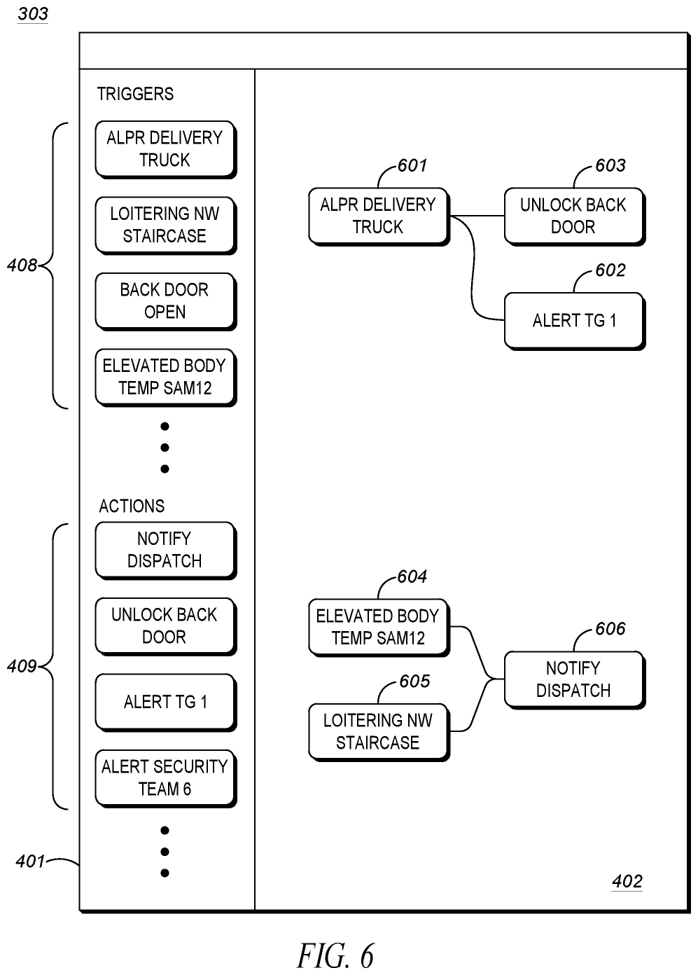

As illustrated in FIG. 6, a single trigger may be associated with multiple actions. Thus, the trigger “ALPR delivery truck” 601 may be associated with action “unlock back door” 603 as well as associated with “alert TG 1” 602. When this workspace is uploaded to workflow server 102, the automatic license plate detected for the delivery truck will cause both the back door to unlock and an alert to be sent on talkgroup #1.

In a similar manner multiple triggers may be associated with a single action. Thus, both the triggers “elevated body tem SAM 12” 604 and “loitering NW staircase” will cause the action of “notify dispatch” 606. Thus, when officer SAM 12 has an elevated body temperature dispatch is notified, and when loitering is detected in the NW staircase, dispatch is notified.

As mentioned above, users can create and implement workflows by associating a trigger with a particular action. Once the trigger is detected, the associated action is executed. However, when a user (for example, a person constructing a workflow) is trying to create or edit a workflow, the user may not be aware that the workflow may lead to many unnecessary triggers that result in false alarms or false notifications. For example, a user may select a trigger as “Loitering detected at door A” but is not aware that it is common for workers to gather at door A for coffee. Having the security guard attend to these triggers may be a waste of time and effort for security personnel and potentially overload the security personnel.

Further, in some situations it would be beneficial if workflows can be automatically created, modified, or suggested to a user. For example, it would be beneficial if a workflow could be automatically generated or suggested based upon a high probability of overloading of resources with a user-created workflow. In particular, it would be beneficial if a workstation (or server) can detect the probability that a resource will be overloaded if a user-created workflow is implemented, and determine an alternate-suggested workflow to reduce the chances that a resource will be overloaded. The alternate-suggested workflow can then be implemented or suggested as a newly-created workflow.

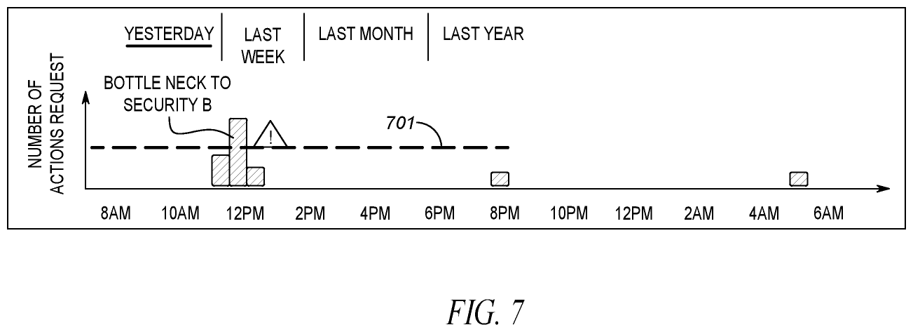

Consider the following example: Assume that a workflow is created by a user that has a trigger of “loitering detected by door A”. The trigger has an associated action to “notify security team via radio communication”. Assume also that between the times of 11 AM to 12 PM, the security team has a history of being preoccupied with other matters (e.g., lunch breaks may occur at 11:30 AM that cause heavy traffic and various alerts to security, along with reduced security personnel). It would be beneficial if any trigger implemented does not cause further work for the security team between 11 AM and 12 PM. This is illustrated in FIG. 7.

As shown in FIG. 7 a workload for the security team over a particular time period (e.g., day, week, month, year) is shown. In one embodiment, this workload for a user or group is a number of times any implemented workflow triggers result in an action involving Security B, over a past time period. Also shown is a threshold level 701 (workload limit), where it is deemed that the security team cannot handle any more work. As is evident, between the hours of 11 AM and 12 PM, the workload for the security team passed this limit once yesterday, but passed it 8 times last week (not shown in FIG. 7), and 42 times last month (not shown in FIG. 7). The addition of additional work between 11 AM and 12 PM would only add to the already-stressed workload for the security team and may cause the workload to exceed limit 701 for multiple time periods.

In another embodiment, the workload will be calculated as described above, but also take into consideration any added “work” a user-created workflow will add to the workload. For example, suppose that the average workload for a security team is 15 “actions” a day between the hours of 11 AM and 12 PM. Also assume that a user-created workflow will add an average of 4 “actions” between the hours of 11 AM and 12 PM. The workload for the security team will then be 19 (15+4).

With this in mind, it would be beneficial if a user wishing to implement the above-described workflow could be provided with alternate-suggested workflows that reduce the workload of the security team between the hour of 11 AM and 12 PM.

In order to address this issue, workstation 101 (or alternatively server 102) will provide alternate-suggested workflows to a user when:
Scenario A: historical data suggests that an individual or group effected by the action of the user-created workflow has a historical workload over a threshold for various time periods encompassed by the trigger; or
Scenario B: historical data shows that an individual or group effected by the action of the user-created workflow does not have a historical workload over the threshold for various time periods encompassed by the trigger, however, the implementation of the user-created workflow will cause the individual or team effected by the action of the user-created workflow to be predicted to have a workload over the threshold for various time periods encompassed by the user-created workflow.

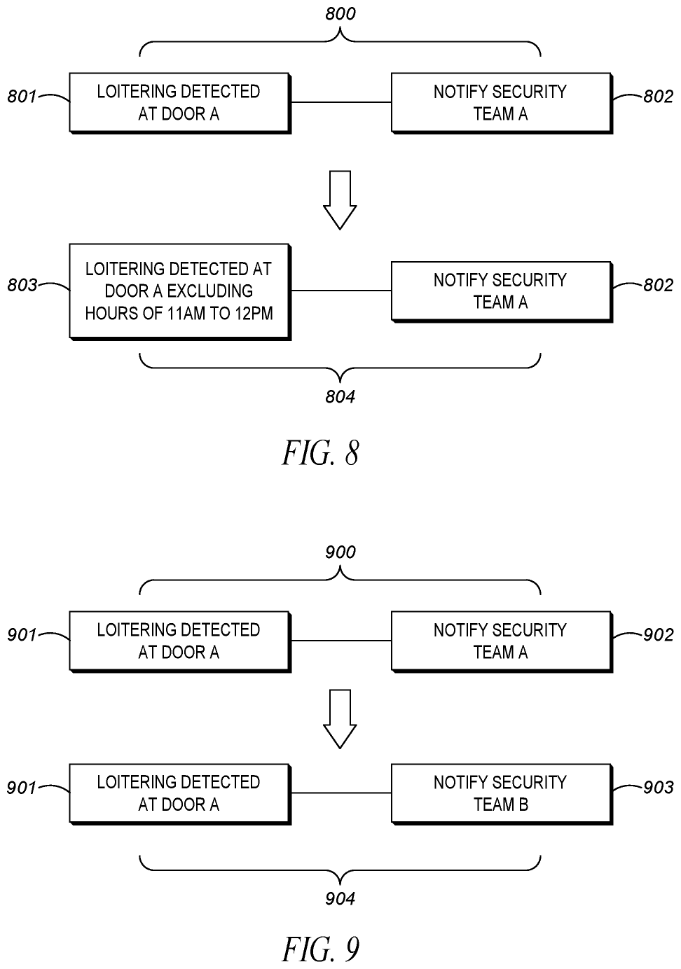

In one embodiment, processor 302 will provide alternate-suggested workflows during time periods where scenario A and/or scenario B exist. This is illustrated in FIG. 8. As shown in FIG. 8, a user, using workstation 101, creates user-created workflow 800 having trigger 801 and action 802. The trigger comprises “loitering detected at by door A”, while the action comprises “notify security team A”. If either scenario A or scenario B apply to user-created workflow 800, logic circuitry 302 may provide alternate-suggested workflow 804 that modifies trigger 801. This is illustrated in FIG. 8 by having trigger 801 modified to trigger 803 by eliminating time periods from trigger 801 where scenarios A and B exist. Thus, in the example shown in FIG. 8, logic circuitry 302 determined that scenario A or B existed and provided an alternate-suggested workflow 804 which scenario A or B does not exist

The alternate-suggested workflows may also comprise modifying the action of a user-created workflow as well. This is illustrated in FIG. 9. As shown in FIG. 9 a user, using workstation 101, creates user-created workflow 900 having trigger 901 and action 902. The trigger comprises “loitering detected at door A”, while the action comprises “notify security team A”. If either scenario A or scenario B apply to user-created workflow 900, logic circuitry 302 may provide an alternate-suggested workflow 904 that modifies action 902. This is illustrated in FIG. 9 by having action 902 modified to action 903 by notifying an alternate security team (security team B).

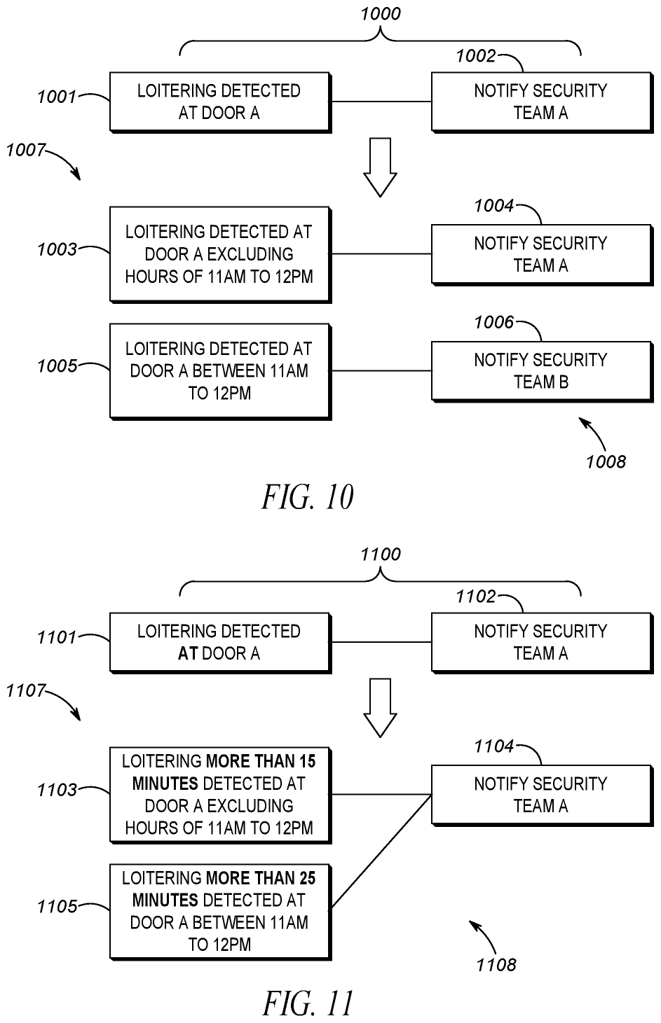

The alternate-suggested workflows may also modify both the trigger and the action of the user-created workflow as well. This is illustrated in FIG. 10. As shown in FIG. 10 a user, using workstation 101, creates user-created workflow 1000 having trigger 1001 and action 1002. The trigger comprises “loitering detected at door A”, while the action comprises “notify security team A”. If either scenario A or scenario B applies to workflow 1000, logic circuitry 302 may provide alternate-suggested workflow 1007 and 1008 that modifies both trigger 1001 and action 1002 of user-created workflow 1000. This is illustrated in FIG. 10 by having two provided alternate-suggested workflows 1007 and 1008 replace the single user-created workflow 1000. More particularly suggested triggers 1003 and 1005 replace trigger 1001, and suggested actions 1004 and 1006 replace action 1002. Thus, the alternate-suggested workflows comprise a first trigger of “Loitering detected at door A excluding hours of 11 AM to 12 PM” associated with a first action of “Notify Security Team A”. The alternate-suggested workflows also comprise a second trigger of “Loitering detected at door A between 11 AM and 12 PM” associated with a second action of “Notify Security Team B”.

It should be noted that the workflows created in response to scenario A or scenario B existing within a user-created workflow are termed “alternate-suggested” workflows since they are alternative workflows to the user-created workflows, and they are merely suggested to the user, as opposed to actually being implemented. The user has the option of choosing the alternate-suggested workflows to implement.

The alternate-suggested workflows may also comprise modifying a threshold or redefining multiple different thresholds of the trigger of the user-created workflow as well. This is illustrated in FIG. 11. As shown in FIG. 11 a user, using workstation 101, creates user-created workflow 1100 having trigger 1101 and action 1102. The trigger comprises “loitering detected at door A”, while the action comprises “notify security team A”. If either scenario A or scenario B apply to user-created workflow 1100, logic circuitry 302 may provide an alternate-suggested workflow 1108 that comprises two different triggers 1103 and 1105 that have two different thresholds for the triggers at two different criteria conditions (in this example, two different time period). Trigger 1103 has a lower threshold of 15 minutes of loitering detected at the time period of all days excluding hours between 11 AM to 12 PM (for example, trigger is fired if a person is loitering at Door A for 16 minutes within 11.05 AM to 11.21 AM). Trigger 1105 has a higher threshold of 25 minutes of loitering detected at the time period between 11 AM to 12 PM (for example, trigger is fired if a person is loitering at Door A for 26 minutes within 11.05 AM to 11.31 AM). With this alternate-workflow 1108, the trigger is less likely to happen during the hour of 11 AM to 12 PM and thus will reduce the workload of Security Team A during that hour of 11 AM to 12 PM while maintaining the overall security level of Door A.

As is evident, FIG. 8, FIG. 9, FIG. 10 and FIG. 11 illustrate alternate-suggested workflows being provided for a user-created workflow. As discussed above, the user-created workflow resulted in either scenario A or scenario B occurring for the subject in the action of the user-created workflow. It should be noted that any alternate-suggested workflows should not cause scenario A or scenario B to occur for the subject of the action in the alternate-suggested workflows. Thus, in order to determine 1) that a user-created workflow will cause scenario A or scenario B to occur, and 2) that the alternate-suggested workflows will not have scenario A or scenario B to occur, the following information will need to be determined by processor 302:
(1) A subject effected by the action of the user-created workflow (herein referred to as “the first subject”);
(2) A predicted frequency of the user-created workflow being executed;
(3) A historical workload for the first subject;
(4) A subject effected by the action of the alternate-suggested workflow (herein referred to as “the second subject” which may be equal to the first subject);
(5) A frequency of the alternate-suggested workflow being executed; and
(6) A historical workload for the second subject.

### (1) Determining the First Subject

The determination of the first subject is straight forward. As discussed above, every workflow comprises a trigger and an action. The action frequently involves something being done by an individual or group. The first subject comprises the individual or group mentioned in the action of the user-created workflow. Thus, processor 302 will analyze the action of the user-created workflow to determine the first subject.

(2) Determining a Predicted Frequency of the User-Created Workflow being Executed

In one embodiment of the present invention historic video is analyzed to determine when a user-created workflow would be historically executed. The historic video is preferably security camera video stored in database 301. However, if historic video is not available, a predicted frequency of the user-created workflow being executed may be determined from similar triggers in other workflows. This information is stored in database 301. Processor 302 then accesses database 301 to determine how many times the user-created workflow would be executed over a specific period of time. This calculation gives the frequency of the user-created workflow being executed over various time periods.

### (3) Determining a Historical Workload for the First Subject

The historical workload for the first subject is determined by processor 302 determining the frequency of all workflows being executed that involve the first subject.

### (4) Determining a Second Subject

The determination of the second subject is straight forward. As discussed above, every workflow comprises a trigger and an action. The action frequently involves something being done by an individual or group. The second subject comprises the individual or group mentioned in the action of the alternate-suggested workflow. Thus, processor 302 will analyze the action of the alternate-suggested workflow to determine the second subject.

(5) Determining a Frequency of the Alternate-Suggested Workflow being Executed

In one embodiment of the present invention historic video is analyzed to determine when an alternate-suggested workflow would be historically executed. The historic video is preferably security camera video stored in database 301. However, if historic video is not available, a predicted frequency of the alternate-suggested workflow being executed may be determined from similar triggers in other workflows. This information is stored in database 301. Processor 302 then accesses database 301 to determine how many times the alternate-suggested workflow would be executed over a specific period of time. This calculation gives the frequency of the alternate-suggested workflow being executed over various time periods.

### (6) Determining a Historical Workload for the Second Subject

The historical workload for the second subject is determined by processor 302 determining the frequency of all workflows being executed that involve the second subject.

Once the above is determined, processor 302 can easily determine if scenario A or scenario B occurs for a user-created workflow. It should be noted that having scenario A or B exist for the user-created workflow will cause processor 302 to provide alternate-suggested workflows to the user. Additionally, processor 302 only provides alternate-suggested workflows to the user that do not have scenario A or B existing for the alternate-suggested workflows.

### Determining if Scenario a Exists for the First Subject in the User-Created Workflow

In order to determine if historical data suggests that the first subject has a historical workload over a threshold for various time periods encompassed by the trigger, logic circuitry 302 will determine (1) to find the first subject, and then determine (3) to determine if the first subject has a workload that exceeds a threshold for the various time periods.

### Determining if Scenario B Exists for the First Subject in the User-Created Workflow

In order to determine if historical data shows that the first subject does not have a historical workload over the threshold for various time periods encompassed by the trigger, however, the implementation of the user-created workflow will cause the first subject to be predicted to have a workload over the threshold for various time periods encompassed by the user-created workflow, logic circuitry 302 firsts calculates (1) and (3) to determine historic workloads for the first subject, then calculates (2) and adds the historic workloads for the first subject.

### Determining if Scenario a Exists for the Second Subject in the Alternate-Suggested Workflow

In order to determine if historical data suggests that the second subject has a historical workload over a threshold for various time periods encompassed by the trigger of the alternate-suggested workflow, logic circuitry 302 will determine (4) to find the second subject, and then determine (6) to determine if the second subject has a workload that exceeds a threshold for the various time periods.

### Determining if Scenario B Exists for the Second Subject of the Alternate-Suggested Workflow

In order to determine if historical data shows that the second subject does not have a historical workload over the threshold for various time periods encompassed by the trigger, however, the implementation of the alternate-suggested workflow will cause the second subject to be predicted to have a workload over the threshold for various time periods encompassed by the alternate-suggested workflow, logic circuitry 302 firsts calculates (4) and (6) to determine historic workloads for the second subject, then calculates (5) and adds the historic workloads for the second subject.

With the above in mind, workstation 101 provides for an apparatus comprising database 301 comprising actions for workflows along with time periods when the actions for the workflows were executed. Logic circuitry 302 is provided and configured to detect a user-created workflow from GUI 304, wherein the user-created workflow comprises a first trigger and a first action, determine a first subject effected by the first action of the user-created workflow, and determine a predicted frequency of the user-created workflow being executed. Logic circuitry 302 is also configured to determine a historical workload for the first subject and determine that (a) the first subject has a historical workload over a first threshold for various time periods encompassed by the first trigger of the user-created workflow, or (b) the implementation of the user-created workflow will cause the first subject to have a workload over the first threshold for various time periods encompassed by the first trigger of the user-created workflow. Logic circuitry is also configured to determine an alternate-suggested workflow having at least one of a second trigger and a second action, determine a second subject effected by the second action, and provide the alternative-suggested workflow to the user via GUI 304, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

As discussed, the second trigger may operate over a different time period than the first trigger. For example, the second trigger may have time periods for the second trigger to activate that differ from time periods where the first trigger activates.

Additionally, the second trigger may operate using a different thresholds than the first trigger. For example, the second trigger may operate using facial recognition, while the first threshold does not.

Additionally, the first subject and the second subject may be the same subject. Thus, the same person may be the subject of both the first and the second actions.

As discussed above, graphical-user interface (GUI) 306 is configured to display the user-created workflow and the alternate-suggested workflow and receive a user input that accepts or rejects the alternate-suggested workflow. The user input may simply comprise the selection of a soft key displayed on monitor 303.

As discussed above, video analytics may be utilized in determining historic workloads. When this is the case, workstation 101 comprises a database comprising triggers and actions for workflows and historical camera video footages. Logic circuitry 302 is provided and configured to detect a user-created workflow from GUI 304 wherein the user-created workflow comprises a first trigger and a first action and determine a first subject mentioned in the action of the user-created workflow.

Since logic circuitry 304 will perform video analytics on historical video to determine workloads, database 301 comprises various VAEs, and logic circuitry 302 is configured to determine a video analytic engine (VAE) used to detect the first trigger and use the VAE to determine a frequency of the first trigger from the frequency of detection of the first trigger in the historical camera video. Logic circuitry 304 is configured to determine a workload for the first subject based on the frequency of the first trigger, and determine that (a) the first subject has a historical workload over a first threshold for various time periods encompassed by the trigger of the user-created workflow, or (b) the implementation of the user-created workflow will cause the first subject to have a workload over the first threshold for various time periods encompassed by the trigger of the user-created workflow.

Logic circuitry 302 is configured to determine an alternate-suggested workflow having a second trigger and a second action, wherein at least one of the second trigger and the second action differs from the first trigger and the first action, determine a second subject mentioned in the second action, determine a video analytic engine (VAE) used to detect the second trigger, and use the VAE to determine a frequency of the second trigger from the frequency of detection of the second trigger in the historical camera video, determine a workload for the second subject based on the frequency of the second trigger, and provide the alternative-suggested workflow to the user, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

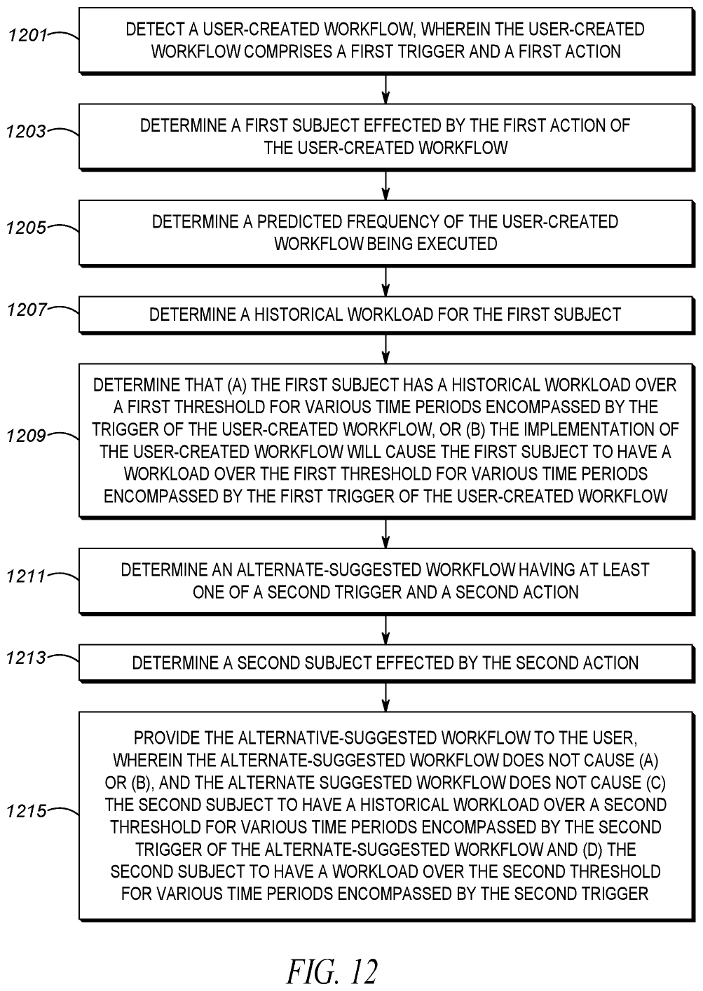

FIG. 12 is a flow chart showing operation of the workstation of FIG. 1. The logic flow begins at step 1201 where logic circuitry 302 detects a user-created workflow, wherein the user-created workflow comprises a first trigger and a first action. At step 1203, logic circuitry 302 determines a first subject affected by the first action of the user-created workflow. A predicted frequency of the user-created workflow being executed is determined at 1205 and a historical workload for the first subject is determined at step 1207.

The logic flow continues to step 1209 where logic circuitry 302 determines that (a) the first subject has a historical workload over a first threshold for various time periods encompassed by the trigger of the user-created workflow, or (b) the implementation of the user-created workflow will cause the first subject to have a workload over the first threshold for various time periods encompassed by the first trigger of the user-created workflow. When this is determined, the logic flow continues to step 1211 where logic circuitry 302 determines an alternate-suggested workflow having at least one of a second trigger and a second action. The logic flow continues to step 1213 where logic circuitry 302 determines a second subject affected by the second action. Finally, at step 1215 logic circuitry 302 provides the alternative-suggested workflow to the user, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a database comprising actions for workflows along with time periods when the actions for the workflows were executed;
logic circuitry configured to:
detect a user-created workflow, wherein the user-created workflow comprises a first trigger and a first action;
determine a first subject effected by the first action of the user-created workflow;
determine a predicted frequency of the user-created workflow being executed;
determine a historical workload for the first subject;
determine that (a) the first subject has a historical workload over a first threshold for various time periods encompassed by the first trigger of the user-created workflow, or (b) the implementation of the user-created workflow will cause the first subject to have a workload over the first threshold for various time periods encompassed by the first trigger of the user-created workflow;
determine an alternate-suggested workflow having at least one of a second trigger and a second action;
determine a second subject effected by the second action;
provide the alternative-suggested workflow to the user, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

2. The apparatus of claim 1 wherein the second trigger operates over a different time period than the first trigger.

3. The apparatus of claim 1 wherein the second trigger operates using a different threshold than the first trigger.

4. The apparatus of claim 1 wherein the first subject and the second subject are the same subject.

5. The apparatus of claim 1 further comprising:
a graphical-user interface (GUI) configured to display the user-created workflow and the alternate-suggested workflow and receive a user input that accepts or rejects the alternate-suggested workflow.

6. An apparatus comprising:
a database comprising triggers and actions for workflows and historical camera video footages;
logic circuitry configured to:
detect a user-created workflow, wherein the user-created workflow comprises a first trigger and a first action;
determine a first subject mentioned in the action of the user-created workflow;
determine a video analytic engine (VAE) used to detect the first trigger;
use the VAE to determine a frequency of the first trigger from a frequency of detection of the first trigger in the historical camera video;
determine a workload for the first subject based on the frequency of the first trigger;
determine that (a) the first subject has a historical workload over a first threshold for various time periods encompassed by the trigger of the user-created workflow, or (b) the implementation of the user-created workflow will cause the first subject to have a workload over the first threshold for various time periods encompassed by the trigger of the user-created workflow;
determine an alternate-suggested workflow having a second trigger and a second action, wherein at least one of the second trigger and the second action differs from the first trigger and the first action;
determine a second subject mentioned in the second action;
determine a video analytic engine (VAE) used to detect the second trigger;
use the VAE to determine a frequency of the second trigger from the frequency of detection of the second trigger in the historical camera video;
determine a workload for the second subject based on the frequency of the second trigger; and
provide the alternative-suggested workflow to the user, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

7. The apparatus of claim 6 wherein the second trigger operates over a different time period than the first trigger.

8. The apparatus of claim 6 wherein the second trigger operates using a different threshold than the first trigger.

9. The apparatus of claim 6 wherein the first subject and the second subject are the same subject.

10. The apparatus of claim 6 further comprising:
a graphical-user interface (GUI) configured to display the user-created workflow and the alternate-suggested workflow and receive a user input that accepts or rejects the alternate-suggested workflow.

11. A method comprising the steps of:
detecting a user-created workflow, wherein the user-created workflow comprises a first trigger and a first action;
determining a first subject effected by the first action of the user-created workflow;
determining a predicted frequency of the user-created workflow being executed;
determining a historical workload for the first subject;
determining that (a) the first subject has a historical workload over a first threshold for various time periods encompassed by the trigger of the user-created workflow, or (b) the implementation of the user-created workflow will cause the first subject to have a workload over the first threshold for various time periods encompassed by the first trigger of the user-created workflow;
determining an alternate-suggested workflow having at least one of a second trigger and a second action;
determining a second subject effected by the second action;
providing the alternative-suggested workflow to the user, wherein the alternate-suggested workflow does not cause (a) or (b), and the alternative-suggested workflow does not cause (c) the second subject to have a historical workload over a second threshold for various time periods encompassed by the second trigger of the alternate-suggested workflow and (d) the second subject to have a workload over the second threshold for various time periods encompassed by the second trigger.

12. The method of claim 11 wherein the second trigger operates over a different time period than the first trigger.

13. The method of claim 11 wherein the second trigger operates using a different threshold than the first trigger.

14. The method of claim 11 wherein the first subject and the second subject are the same subject.

15. The method of claim 11 further comprising the step of:
displaying the user-created workflow and the alternate-suggested workflow on a graphical-user interface (GUI); and
receiving a user input that accepts or rejects the alternate-suggested workflow.
